(19) United States
(12) Patent Application Publication
(10) Pub. No.: US 2016/0350494 A1
(43) Pub. Date: Dec. 1, 2016

(54) USER INTERFACE FOR CLINICAL MEASURES ANALYTICS

(71) Applicant: SAP SE, Walldorf (DE)

(72) Inventors: Martin Krauss, Potsdam (DE); Matthias Steinbrecher, Potsdam (DE); Siegfried Gessulat, Berlin (DE); Jan Matthias Pilzer, Potsdam (DE)

(21) Appl. No.: 15/167,296

(22) Filed: May 27, 2016

Related U.S. Application Data
(60) Provisional application No. 62/168,375, filed on May 29, 2015.

(51) Int. Cl. G06F 19/00; G06T 11/20

(52) U.S. Cl. CPC G06F 19/325; G06T 11/206

(57) ABSTRACT

Implementations of the present disclosure are directed to generating and displaying a user interface (UI) for clinical measures analytics, and include actions of receiving patient care data, processing the patient care data based on a measure to provide a graphical representation of the patient care data, and displaying a graphical representation of the patient care data based on the measure, the graphical representation including a measured time frame and an actionable time frame.

### CROSS-REFERENCE TO RELATED APPLICATIONS

This applications claims the benefit of U.S. Prov. App. No. 62/168,375, filed on May 29, 2015, the disclosure of which is expressly incorporated herein by reference in the entirety for all purposes.

### BACKGROUND

Data visualization enables users to see, study, and explore data underling a relevant topic. For example, in the field of cancer causes, data visualization has been used to study and provide insight into the growth of cancer, patient demographics, and treatment patterns.

### SUMMARY

Implementations of the present disclosure include computer-implemented methods for generating and displaying a user interface (UI) for clinical measures analytics. In some implementations, methods include actions of receiving patient care data, processing the patient care data based on a measure to provide a graphical representation of the patient care data, and displaying a graphical representation of the patient care data based on the measure, the graphical representation including a measured time frame and an actionable time frame.

Implementations of the present disclosure can include one or more of the following features: the graphical representation depicts a number of patients that should have received treatment and that have received treatment within respective periods of the measured time frame, and provides a rolling rate that is relevant for the measure; the actionable time frame depicts a number of patients that are actionable with respect to the treatment; actions further include displaying a graphical statistical summary based on the patient care data, the graphical statistical summary depicting a current value for the particular measure, as well as potential high values and potential low values that are determined based on the actionable time frame; and the measure includes data that is indicative of a quality of care for one or more of a practice and a physician.

The present disclosure also provides one or more non-transitory computer-readable storage media coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example system in accordance with implementations of the present disclosure.

FIG. 2 depicts an example user interface (UI) for clinical measures analytics in accordance with implementations of the present disclosure.

FIG. 3 is a schematic illustration of example computer systems that can be used to execute implementations of the present disclosure.

Like reference symbols in the various drawings indicate like elements.

### DETAILED DESCRIPTION

Implementations of the present disclosure are generally directed to generating and displaying a user interface (UI) for clinical measures analytics. More particularly, implementations of the present disclosure are directed to generating and displaying a UI that provides graphical summaries of respective measures. In some implementations, patient data is received that is relevant to a particular measure, the patient data is processed to provide a graphical representation of the measure, and a data visualization is displayed, which includes the graphical representation in view of a measured time frame and an actionable time frame. In some examples, the patient data is anonymized, such that data associated with any particular patient is not identifiable from the graphical representation.

Implementations of the present disclosure will be described with reference to an example context. The example context includes cancer treatment (e.g., administering chemotherapy). It is contemplated, however, that implementations of the present disclosure are applicable to any appropriate context (e.g., treatment for ailments generally).

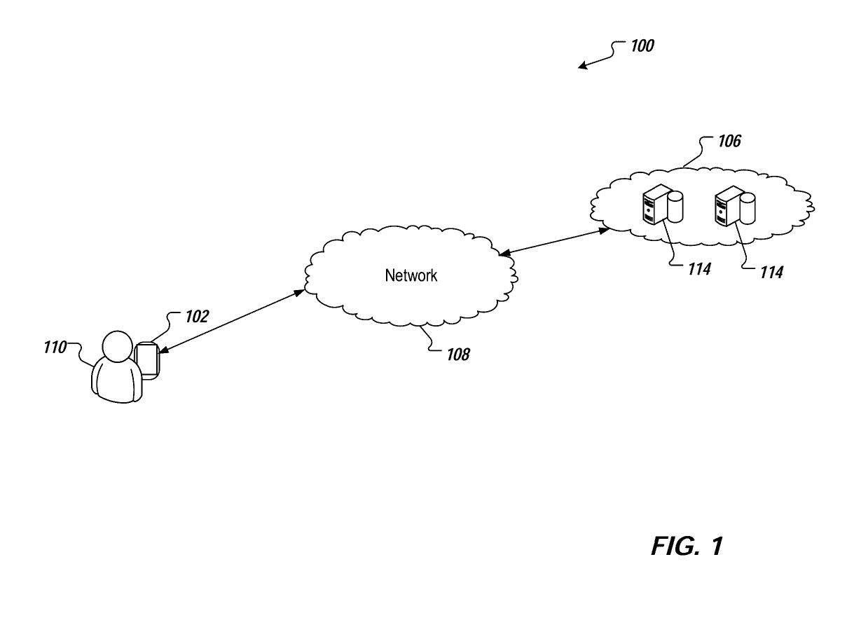

FIG. 1 depicts an example system 100 in accordance with implementations of the present disclosure. In some examples, the example system 100 enables data visualizations to be created and displayed, which includes a graphical representation of patient care data in view of a measured time frame and an actionable time frame. The example system 100 includes a computing device 102, a back-end system 106, and a network 110. In some examples, the communication device 102 is operated by a user 110. An example user can include a healthcare provider (e.g., clinician, doctor). In the depicted example, the computing device 102 is provided as a smartphone. It is contemplated, however, that implementations of the present disclosure can be realized with any appropriate computing device (e.g., smartphone, tablet computing device, laptop computer, desktop computer). In some examples, the network 110 includes a local area network (LAN), wide area network (WAN), the Internet, or a combination thereof, and connects web sites, user devices (e.g., the computing device 102), and the back-end systems (e.g., back-end system 106). In some examples, the network 110 can be accessed over a wired and/or a wireless communications link. For example, mobile computing devices, such as smartphones can utilize a cellular network to access the network 110.

In the depicted example, the back-end system 106 includes at least one server system 114. In some examples, the at least one server system 114 hosts one or more computer-implemented services that users can interact with using computing devices. For example, the computing device 102 can be used to communicate with a service hosted by the back-end system 106 over the network 110. In some examples, the computing device 102 includes a computer-executable application executed thereon, which can be used to log into the service and establish a communication session between the computing device 102 and the back-end system 106. For example, the computing device 102 can execute a mobile application (mobile app) to access the back-end system 106. In some examples, the computing device 102 includes a web browser application executed thereon, which can be used to display one or more web pages of the service, the user interacting with the service through the web page(s).

In the depicted example, the back-end system 106 includes at least one server system 114. In some examples, the at least one server system 114 hosts one or more computer-implemented services that users can interact with using computing devices. As described in further detail herein, the back-end system 106 can host a clinical measures analytics (CMA) system. In some implementations, the back-end system 106 receives data from and provides notifications to the computing device 102, and one or more healthcare provider facilities (e.g., clinic, hospital) (not shown) over the network 110.

In some implementations, a CMA system is provided. In some examples, the CMA system can be provided as one or more computer-executable programs executed by one or more computing devices. For example, the CMA system can be hosted by the back-end system 106 of FIG. 1. In some implementations, the CMA system processes patient care data to provide graphical representations, as described herein. In some examples the CMA system processes the patient care data in view of one or more measures that are indicative of a quality of care for practices and physicians (e.g., the quality of cancer care). For example, and continuing with the example context discussed above, the patient care data can provide that a particular healthcare provider (e.g., clinician, doctor) reports 100 patients over the past year, where 75 of the patients were diagnosed at least 120 days ago, of which 50 patients received the expected care, 25 patients have been reported in the past 120 days, of which 5 have so far received the expected care, and there are 20 actionable patients remaining.

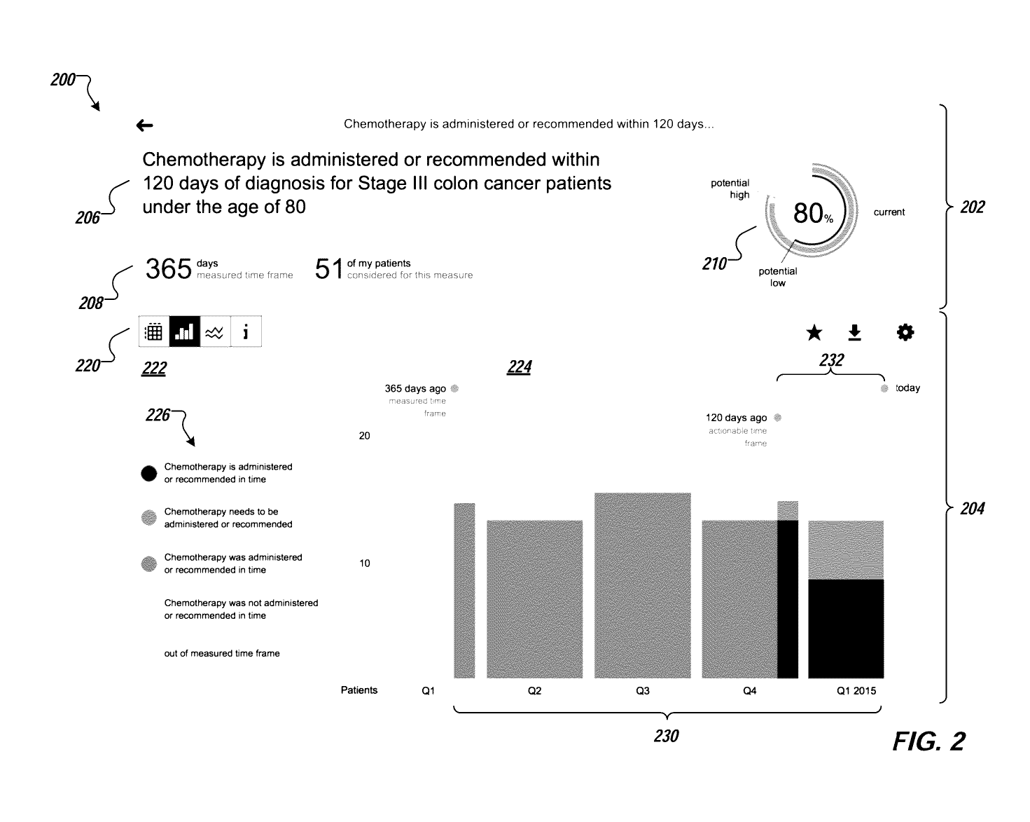

FIG. 2 depicts an example UI 200 for clinical measures analytics in accordance with implementations of the present disclosure. In some implementations, the UI 200 provides a visual report on patient care for a particular healthcare provider (e.g., clinic, doctor). In the depicted example, the UI 200 includes a header portion 202 and a body portion 204.

In some implementations, the header portion 202 provides a description 206, a textual data summary 208, and a graphical statistical summary 210. In some examples, the description 206 indicates a measure being considered (e.g., “Chemotherapy is administered or recommended within 120 days of diagnosis for Stage III colon cancer patients under the age of 80”). In some examples, the textual data summary 208 indicates a time frame, over which the analytics are conducted (e.g., “365 days measured time frame”), and a number of patients considered of the particular healthcare provider being considered for the measure (e.g., “51 of my patients considered for this measure”). In some examples, the graphical statistical summary 210 provides a summary of data reflected in the body portion 204, as discussed in further detail below.

In some implementations, the body portion 204 provides textual and/or graphical summaries of data underlying the measure (e.g., identified in the description 206). In some examples, the body portion 204 includes a summary menu 220 and a graphical summary 222. In some examples, a user can select a type of graphical summary to be displayed in the body portion 204 from the menu 220 (e.g., table, column graph, line graph, textual information). In the example of FIG. 2, a column graph 224 is depicted (e.g., selected from the menu 220) along with a legend 226. In some examples, the column graph 224 graphically depicts the measure being considered (e.g., provided in the description 206) for patients of the particular healthcare provider. More specifically, the column graph 224 of FIG. 2 provides a graphical representation (visualization) of the number of patients that should have or have received treatment on a quarterly basis within the measured time frame 230 (e.g., 365 days). The column graph 224 of FIG. 2 provides a rolling, 1-year/365-day rate that is relevant for the measure, and provides an actionable time frame 232 for the measure (e.g., 120 days from a current date (“today”)). The actionable time frame 232 depicts the number of patients that are actionable (e.g., patients that can be acted on within the actionable time frame). In the example of FIG. 2, the actionable time frame 232 graphically depicts the number of patients, for which chemotherapy can be administered or recommended.

In some implementations, the graphical statistical summary 210 is provided based on the patient care data underlying the data visualization (e.g., the column graph 224) displayed in the body portion 204. In some examples, the graphical statistical summary 210 depicts a current value for the particular measure, as well as potential high values and potential low values. In some examples, the potential high values and the potential low values are provided based on the patient care data falling within the actionable time frame.

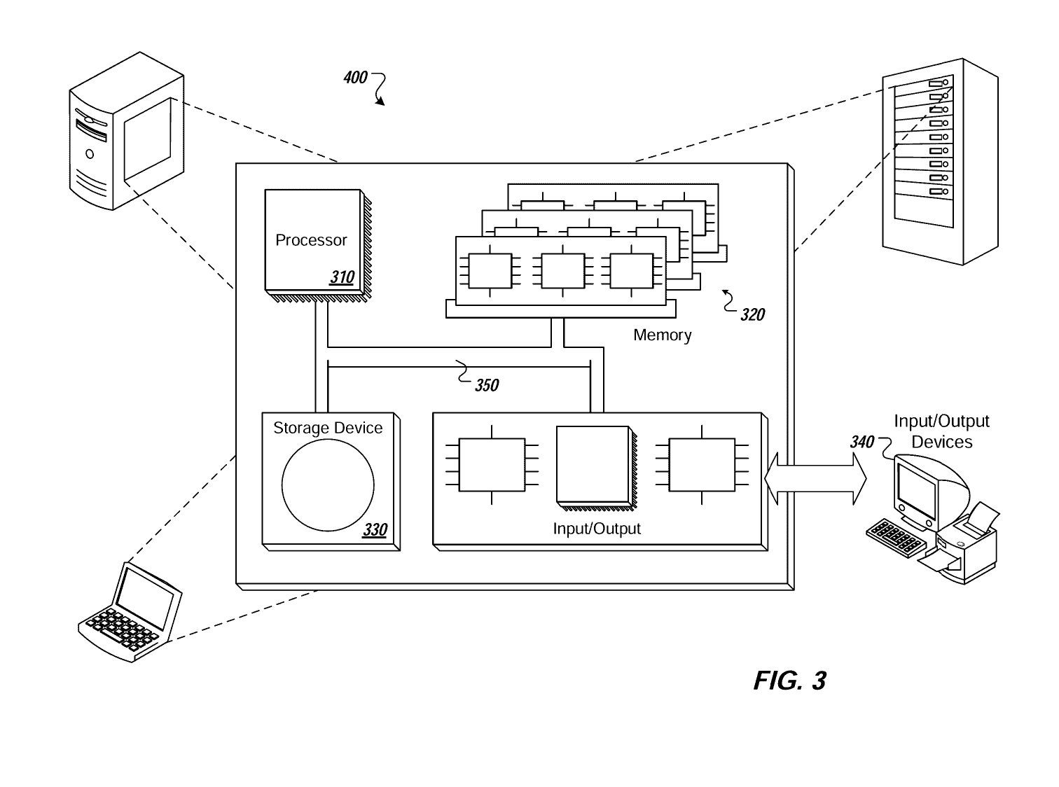

Referring now to FIG. 3, a schematic diagram of an example computing system 300 is provided. The system 300 can be used for the operations described in association with the implementations described herein. For example, the system 300 may be included in any or all of the server components discussed herein. The system 300 includes a processor 310, a memory 320, a storage device 330, and an input/output device 340. Each of the components 310, 320, 330, 340 are interconnected using a system bus 350. The processor 310 is capable of processing instructions for execution within the system 300. In one implementation, the processor 310 is a single-threaded processor. In another implementation, the processor 310 is a multi-threaded processor. The processor 310 is capable of processing instructions stored in the memory 320 or on the storage device 330 to display graphical information for a user interface on the input/output device 340.

The memory 320 stores information within the system 300. In one implementation, the memory 320 is a computer-readable medium. In one implementation, the memory 320 is a volatile memory unit. In another implementation, the memory 320 is a non-volatile memory unit. The storage device 330 is capable of providing mass storage for the system 300. In one implementation, the storage device 330 is a computer-readable medium. In various different implementations, the storage device 330 may be a floppy disk device, a hard disk device, an optical disk device, or a tape device. The input/output device 340 provides input/output operations for the system 300. In one implementation, the input/output device 340 includes a keyboard and/or pointing device. In another implementation, the input/output device 340 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device) for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method executed by one or more processors, the method comprising:
receiving, by one or more processors, patient care data;
processing, by the one or more processors, the patient care data based on a measure to provide a graphical representation of the patient care data; and
displaying, by the one or more processors, a graphical representation of the patient care data based on the measure, the graphical representation including a measured time frame and an actionable time frame.

2. The method of claim 1, wherein the graphical representation depicts a number of patients that should have received treatment and that have received treatment within respective periods of the measured time frame, and provides a rolling rate that is relevant for the measure.

3. The method of claim 1, wherein the actionable time frame depicts a number of patients that are actionable with respect to the treatment.

4. The method of claim 1, further comprising displaying a graphical statistical summary based on the patient care data, the graphical statistical summary depicting a current value for the particular measure, as well as potential high values and potential low values that are determined based on the actionable time frame.

5. The method of claim 1, wherein the measure comprises data that is indicative of a quality of care for one or more of a practice and a physician.

6. Non-transitory computer-readable storage media coupled to one or more processors and having instructions stored thereon which, when executed by the one or more processors, cause the one or more processors to perform operations comprising:
receiving patient care data;
processing the patient care data based on a measure to provide a graphical representation of the patient care data; and
displaying a graphical representation of the patient care data based on the measure, the graphical representation including a measured time frame and an actionable time frame.

7. The computer-readable storage media of claim 6, wherein the graphical representation depicts a number of patients that should have received treatment and that have received treatment within respective periods of the measured time frame, and provides a rolling rate that is relevant for the measure.

8. The computer-readable storage media of claim 6, wherein the actionable time frame depicts a number of patients that are actionable with respect to the treatment.

9. The computer-readable storage media of claim 6, wherein operations further comprise displaying a graphical statistical summary based on the patient care data, the graphical statistical summary depicting a current value for the particular measure, as well as potential high values and potential low values that are determined based on the actionable time frame.

10. The computer-readable storage media of claim 6, wherein the measure comprises data that is indicative of a quality of care for one or more of a practice and a physician.

11. A system, comprising:
a computing device; and
a computer-readable storage device coupled to the computing device and having instructions stored thereon which, when executed by the computing device, cause the computing device to perform operations comprising:
receiving patient care data;
processing the patient care data based on a measure to provide a graphical representation of the patient care data; and
displaying a graphical representation of the patient care data based on the measure, the graphical representation including a measured time frame and an actionable time frame.

12. The system of claim 11, wherein the graphical representation depicts a number of patients that should have received treatment and that have received treatment within respective periods of the measured time frame, and provides a rolling rate that is relevant for the measure.

13. The system of claim 11, wherein the actionable time frame depicts a number of patients that are actionable with respect to the treatment.

14. The system of claim 11, wherein operations further comprise displaying a graphical statistical summary based on the patient care data, the graphical statistical summary depicting a current value for the particular measure, as well as potential high values and potential low values that are determined based on the actionable time frame.

15. The system of claim 11, wherein the measure comprises data that is indicative of a quality of care for one or more of a practice and a physician.
